(19) United States
(12) Patent Application Publication
(10) Pub. No.: US 2014/0122391 A1
(43) Pub. Date: May 1, 2014

(54) Top-Down Abstraction Learning Using Prediction as a Supervisory Signal

(71) Applicant: 21CT, Inc., Austin, TX (US)

(72) Inventors: Jonathan William Mugan, Buda, TX (US); Matthew Ryan McClain, Austin, TX (US)

(21) Appl. No.: 14/069,363

(22) Filed: Oct. 31, 2013

Related U.S. Application Data
(60) Provisional application No. 61/816,355, filed on Apr. 26, 2013.
(60) Provisional application No. 61/809,768, filed on Apr. 8, 2013.
(60) Provisional application No. 61/720,969, filed on Oct. 31, 2012.

(51) Int. Cl. G06N 99/00

(52) U.S. Cl. CPC G06N 99/005
USPC 706/12

(57) ABSTRACT

A method of machine learning for use with a learning machine which includes a first input sensor adapted to sense an environment, a first output controller adapted to act on the environment, and a computing system including a user input device, a memory, and a processor, includes the steps of providing an event set comprising one or more events, providing a model set adapted to comprise one or more models, and iteratively repeating a sequence of steps for augmenting the event set with the plurality of new events, and acting on the environment using the first output controller.

### CROSS-REFERENCE TO RELATED APPLICATIONS

This application claims benefit of priority from U.S. Patent Application No. 61/720,969 filed Oct. 31, 2012; from U.S. Patent Application No. 61/809,768 filed Apr. 8, 2013; and from U.S. Patent Application No. 61/816,355 filed Apr. 26, 2013; each of which applications is incorporated by reference herein in its entirety.

### GOVERNMENT RIGHTS

Embodiments of the invention were made with government support under contract number AFRL/WPAFB, No. FA8650-12-M-1406 awarded by the Air Force Research Lab and under contract number ONR N00014-13-P-102 awarded by the Office of Naval Research. The government has certain rights in the invention.

### FIELD OF THE INVENTION

Embodiments disclosed herein relate to machine-learning algorithms and learning machines for implementing said algorithms, and more particularly top-down abstraction learning algorithms.

### BACKGROUND OF THE INVENTION

Humans are great at ignoring irrelevant information and focusing on what is important. For instance, we know enough about bananas to be able to buy and eat them, but most of us don't understand their molecular structure because we don't need to. Possibly because we can so effortlessly understand our environment, we have been continually surprised at how difficult it has been to build that ability into a learning machine such as, for example, a robot.

One way to think about the problem is to begin with an overwhelmingly complex sensory input and to search for ways to make it simpler. Examples of this approach include tracking blobs in computer vision, clustering, and principal components analysis. These approaches are unsupervised and bottom-up, but while such approaches can be a necessary starting point, they are not enough. Learning machines, for example, robots, often need to be able to identify small distinctions that lead to big consequences. Imagine being a rat in a Skinner box where you could observe a screen full of complicated shapes. Imagine further that a small dot in the lower right corner of the screen determined whether a painful electric shock would come on the left side of the cage or the right. Bottom-up methods looking at the structure of the data without accounting for the consequences might never find this important distinction.

In the learning process, a supervisory signal tells you if you are right or wrong. Assume, for example that you are trying to learn to hit a baseball. Every time you swing your bat, you get a supervisory signal in the form of seeing if the ball was hit or not. By contrast, if you were just practicing by yourself, swinging the bat, you wouldn't get that signal.

### BRIEF DESCRIPTION OF THE DRAWINGS

FIG. 1 depicts an exemplary dynamic Bayesian network (DBN) and conditional probability table (CPT).

FIG. 2 depicts an exemplary evaluation environment.

FIG. 3 depicts a block diagram representation of an exemplary computer system for use in embodiments of a learning machine.

FIG. 4 depicts an exemplary subgoal planner algorithm.

FIG. 5 depicts an exemplary algorithm to achieve an event.

FIG. 6 depicts an exemplary algorithm.

FIG. 7 depicts a representation of an exemplary file exfiltration scenario.

FIGS. 8A-8E depict DBNs generated by an embodiment of a learning machine.

FIG. 9 depicts steps of an exemplary method for machine learning.

FIG. 10 depicts an exemplary robot.

FIG. 11 depicts an exemplary abstraction learning algorithm.

FIG. 12 depicts an exemplary number line with landmarks.

FIGS. 13A and 13B depict exemplary abstraction hierarchies.

FIG. 14 depicts an exemplary algorithm for updating abstraction hierarchy statistics.

### SUMMARY OF THE CLAIMS

In one aspect, embodiments disclosed herein relate to a method of machine learning for use with a learning machine. The learning machine includes a first input sensor adapted to sense an environment, a first output controller adapted to act on the environment, and a computing system including a user input device, a memory, and a processor. The method steps includes providing an event set comprising one or more events, providing a model set adapted to comprise one or more models wherein each model can predict at least one of the one or more events in the event set, and iteratively repeating the following sequence of steps: sensing the environment with the first input sensor, updating statistics, searching for new distinctions over a first abstraction hierarchy to identify a new distinction that makes a first model more deterministic, wherein the first model is one of the one or more models in the model set, converting the new distinction into a plurality of new events, augmenting the event set with the plurality of new events, and acting on the environment using the first output controller.

In other aspects, embodiments disclosed herein relate to a learning machine including a computing system comprising a user input device, a processor, and a memory, wherein the memory comprises an event set comprising one or more events and a model set adapted to comprise one or more models wherein each model can predict at least one of the one or more events in the event set, a first input sensor coupled to the computing system, the first input sensor adapted to sense an environment, and a first output controller coupled to the computing system, the first output controller adapted to act on the environment. The memory further comprises instructions, which when executed by the processor, cause the learning machine to iteratively repeat the functions of: sensing the environment with the first input sensor, updating statistics, searching for new distinctions over a first abstraction hierarchy to identify a new distinction that makes a first model more deterministic, wherein the first model is one of the one or more models in the model set, converting the new distinction into a plurality of new events, augmenting the event set with the plurality of new events, and acting on the environment using the first output controller.

### DETAILED DESCRIPTION OF THE INVENTION

A learning machine, in embodiments of the invention, employs a top-down approach to learning abstractions. Instead of beginning with a fine-grained resolution of the world and learning abstractions to make it simpler, the exemplary learning machine embodiments described herein begin with a coarse representation of the world and make it finer by learning important distinctions. The learning process balances a trade-off between a representation of the world that is fine enough to be useful, but not so fine as to overwhelm computational resources. A top-down approach requires a supervisory signal, and an exemplary signal comes from trying to predict events known to the learning machine. A rat in a Skinner box, for example, would try to predict when it would get shocked on the right side of the box, and it would search the screen for a feature that would help it to reliably make that prediction.

A top-down approach to learning abstractions has unexpected utility in cyber defense. Current cyber defenses are insufficient to counter the sophistication level of modern attacks. Signature-based detection is too brittle and results in too many false negatives. Attempts have been made to move into machine learning and anomaly-based approaches, but anomaly-based detection is often too myopic and results in too many false positives, and classification-based machine learning can only find what it is told to look for.

An expanded machine-learning algorithm could learn a causal model to represent the entire cyber network and each host end node. Such a learning algorithm would run continuously on the system and monitor activity in real time. With a causal model of the system, the algorithm could anticipate novel attacks, take actions to thwart them, and predict the second-order effects of those actions. Designing such a learning algorithm is a complex task because computer systems generate a flood of information, and the learning algorithm would have to determine which streams of that flood are relevant in which situations. Additionally, the causal mechanisms of a system cannot be learned through observation alone. For example, the observation that prison inmates tend to have tattoos does not mean that tattoos cause crime.

Described here is an embodiment of an expanded machine-learning algorithm called Cy-QLAP, for Cyber Security Qualitative Learner of Action and Perception. Cy-QLAP uses a developmental learning approach. Learning developmentally allows an algorithm to focus on subsets of the environment that are most helpful for learning given its current knowledge. Cy-QLAP also learns by actively exploring the environment. In Cy-QLAP, each model is a little test of the form “if a happens then b will happen.” Then, once it has this model and it notices that ‘a’ happens, QLAP can just watch the world to see if ‘b’ follows. Much as randomized, controlled trials do in science, learning through direct actions allows Cy-QLAP to separate causality from correlation. Since Cy-QLAP is a learning algorithm, it can anticipate scenarios beyond those that were programmed in. Cy-QLAPs actions can naturally lead to subtle responses such as moving a file that is trying to be maliciously accessed or diverting requests to a honeypot. In an embodiment, Cy-QLAP is implemented in a parallel system that runs on top of computing systems to keep them safe.

Tools for cyber-security comprise firewalls, antivirus and anti-malware systems, intrusion detection systems (IDS), and intrusion prevention systems (IPS). Intrusion detection systems can be network-based or host-based. A host-based IDS watches activity on a host and warns an administrator if it suspects malicious activity. An IDS can identify malicious activity by using a set of signatures or by looking for anomalies in behavior. An IPS is just like an IDS, with the addition of taking actions to protect the system, such as blocking a system call that is suspected to be malicious. For example, Rootsense is an intrusion prevention system that correlates events between processes, the file system, memory, and the network. When an application invokes a system call, Rootsense can determine if the process is malicious and terminate it or deny the system call.

Some conventional cyber-defense systems try to identify attacks in progress by watching for anomalies or matching signatures. However, signature-based detection is static and therefore cannot detect new attacks, resulting in too many false negatives; and IDS methods often lead to too many false positives and uncorrelated messages and alerts. Cy-QLAP adopts a different approach to proactively finds vulnerabilities before an attack occurs. Cy-QLAP actively fills in the gaps in its knowledge by asking what would happen if the adversary performed such an action, and then trying it out. Cy-QLAP can then actively protect the system. For example, if the system is currently in state x, and through causal model learning, Cy-QLAP knows that action “a” would lead to bad state y, Cy-QLAP can prevent action “a” from being performed. Because Cy-QLAP has learned this causal model, an attack such as this can be thwarted even if it was not previously conceived of by an analyst.

Many machine learning approaches treat the learning algorithm like a black box that receives input and produces output. Neural networks are an excellent example of this opacity in learning algorithms. As the intelligence and scope of cyber defenses expands, defensive systems will be more like partners and less like computer programs. As with all partnerships, the analyst must be able to communicate with and trust the defense system. If an analyst cannot understand why decisions are made by the system, the system will simply be turned off.

Cy-QLAP is designed so that its data representations correspond to human intuition. Instead of creating one large and cumbersome model of the world, Cy-QLAP breaks its representation of the cyber system up into many small and easily understandable causal models. Each model is based on a contingency, such as: if I close port 25, then email will not function. Humans think naturally in terms of contingencies, and it is even posited that we humans have an innate contingency detection module.

Cy-QLAP begins its learning process with a set of primitive actions, and by using these actions, Cy-QLAP expands its knowledge by learning the effects of those actions. Piaget described how children construct knowledge in stages and learned new concepts on top of those they already know. Focusing on what the learner needs to learn based on its current knowledge helps to narrow the learning problem. This method of learning can be extended with instructors, as discussed by the psychologist Lev Vygotsky. Vygotsky proposed the concept of the zone of proximal development, which leads to the conclusion that a teacher can maximize a child's capabilities by helping the child with tasks at the edge of the child's current knowledge.

To employ Cy-QLAP, an analyst can specify a set of critical assets that should be protected. An example would be that all files of a particular type should be protected from exfiltration. The analyst can direct Cy-QLAP's learning by specifying an initial set of primitive actions and important events. If need be, the analyst can also intervene to help Cy-QLAP stay within its zone of proximal development.

A simulation experiment in a simple environment can demonstrate how an embodiment of Cy-QLAP can use knowledge learned through exploration to take actions to proactively thwart an attack. Cy-QLAP explored an environment consisting of an end node that it was protecting and a virtual machine that Cy-QLAP used to probe the end node. Through its exploration, Cy-QLAP learned the dynamics of the environment. Specifically, it learned that a sensitive file could be exfiltrated when a file share was opened. Cy-QLAP was then asked to use its acquired knowledge to protect the system. Cy-QLAP monitored the system, and when it found that a file share was open, it used its learned knowledge of the dynamics of the system to close it, thus keeping the files from being exfiltrated. Cy-QLAP did not have to be told what the dangers were or how to prevent them; Cy-QLAP learned both how the system could be compromised and how to defend the system. Because Cy-QLAP does not have to be given the dynamics of the system, Cy-QLAP is a domain general defensive system.

Cy-QLAP autonomously learns causal models to predict and control a system. Each causal model has a learned contingency at its core. A contingency is a pair of events that occur together in time such that an antecedent event is followed by a consequent event. An example would be that flipping a light switch (the antecedent event) is soon followed by the light going on (the consequent event). An example that Cy-QLAP could learn on a computer system is that shutting down port 25 causes SMTP email to stop working correctly. Contingencies are a particularly useful method for learning models. They are easy to learn because they only require looking at pairs of events, and they are a natural representation for planning because they indicate how events lead to other events.

Cy-QLAP learns a contingency between an antecedent event e₁ and a consequent event e₂. In an exemplary embodiment, Cy-QLAP learns a contingency using a window of time characterized as soon. For the light switch example, flipping a light switch on (the antecedent event) causes a light to go on (the consequent event) in a small amount of time (the soon window). Mathematically, Cy-QLAP learns a contingency between event e₁ and a consequent event e₂ if the probability that event e₂ occurs in the soon window, given the occurrence of e₁, exceeds the probability that event e₂ occurs in the soon window, plus a penalty. This can be expressed as:

Pr(soon(e₂)|e₁)>Pr(soon(e₂))+penalty

Contingencies form the basis for Dynamic Bayesian Networks (DBNs). DBNs are the mathematical representation of causal models used in Cy-QLAP because they represent changes over time. DBNs are a type of graphical model. Graphical models are used to represent multi-dimensional probability distributions, where variables are nodes and edges capture the conditional dependence between variables.

Due to the large number of variables that Cy-QLAP has to monitor on a computer system, estimating the joint probability distribution of all variables directly is an intractable task. However, since each variable is typically only dependent on a subset of the other variables, a DBN can allow for the compact representation of a probability distribution. For example, if the probability of a value of variable A conditioned on some other variables B and C is independent of the value of a variable D, then P (A|B, C)=P (A|B, C, D). This means that D can be dropped, and Cy-QLAP can concisely represent some small piece of the world.

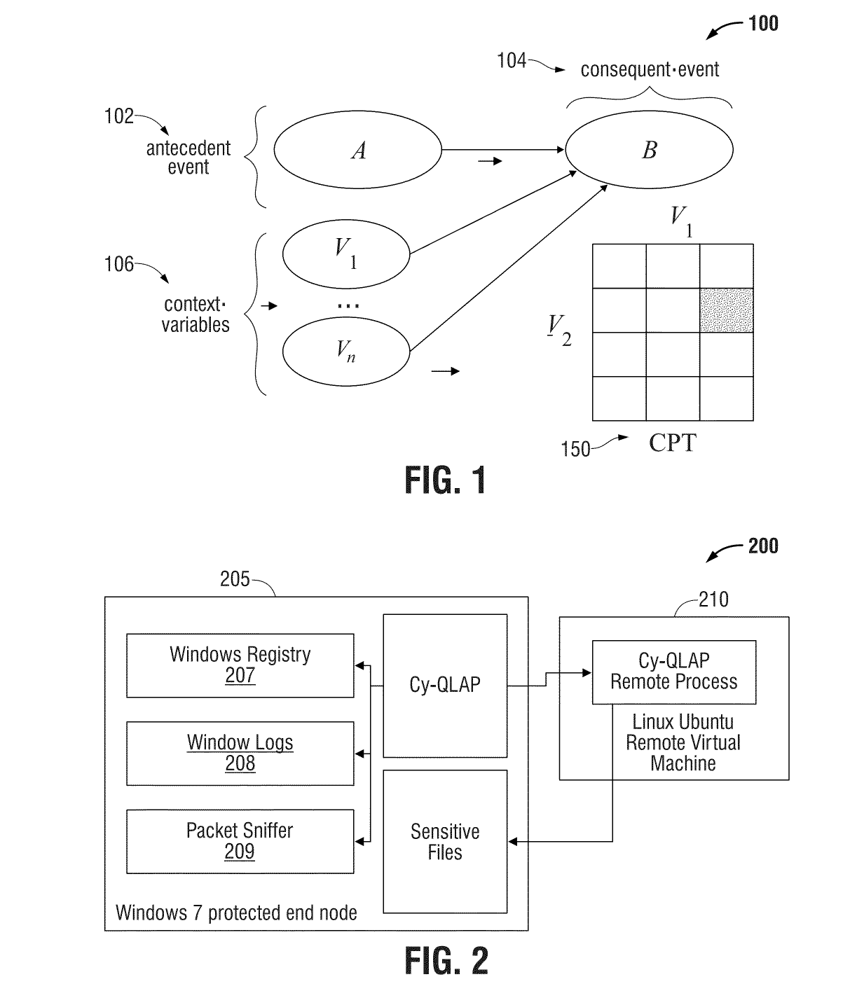

FIG. 1 shows an example DBN 100 in which the antecedent event A (102) (e.g., the light switch is flipped) and the consequent event B (104) (e.g., the light goes on) form the core of the DBN. Once the core of the DBN is created by a contingency, Cy-QLAP identifies the important variables V₁, . . . , Vₙ (106), called context variables, from the set of all variables. Exemplary context values include Boolean values, integers, and continuous variables. A conditional probability table (CPT) (150) gives the probability of the antecedent event A bringing about the consequent event B for each possible value of the context variables V₁, . . . , Vₙ. This means that there is an entry in the CPT for each combination of values V₁, . . . , Vₙ. An exemplary embodiment uses two context variables V₁ and V₂. As illustrated by CPT (150) in FIG. 1, a CPT with two context variables can be depicted as a two-dimensional grid V₁×V₂ where V₁ and V₂ are each discretized into discrete values or ranges of values, each column corresponds to one of the discrete values or range of values of context variable V₁, each row corresponds to a value or range of values of context variable V₂ , and the intersection of each contains a probability value showing the probability that context variable V₁ takes the value corresponding to the column value and that context variable V₂ takes the value corresponding to the row value. Alternative embodiments of a CPT may use more than two context variables, implemented, for example, with a multi-dimensional array.

As Cy-QLAP observes and actively explores the system, it learns the context variables for each DBN model through a process called marginal attribution. Marginal attribution works, in an embodiment, by iteratively adding context variables as long as each new context variable makes the DBN marginally more deterministic. The algorithm examines variables outside of that DBN to determine if adding them would make the DBN more deterministic.

An embodiment uses two exemplary methods to measure determinism. Without being limited by theory, experimental results indicate that it is initially best to find some situation in which the contingency is reliably achieved, and then it is useful to find a representation of the environment that is predictable in all situations. In an embodiment, the level of determinism for each model is measured by the highest probability of any value in the CPT, as long as that value is less than a predetermined threshold, which in an exemplary embodiment is 0.75. (In alternate embodiments the determinism threshold may be different, for example, 0.50, 0.67, 0.70 or 0.80, or the threshold value may be different may vary based on context and/or be controllable by settings or by the analyst). If the highest probability of any value in the CPT is above the threshold (for example, 0.75), the level of determinism is measured by the entropy of the entire CPT.

The result of the learning process is a set of one or more DBNs, where each DBN contains a CPT that gives the probability of the antecedent event leading to the consequent event for each relevant state of the world as described by the context variables. Cy-QLAP learns many small DBNs to model the system, and these DBNs can be chained together to form plans. These plans allow Cy-QLAP to actively protect the system using, in an exemplary embodiment, threat monitoring means and threat intervention means. After the human analyst has specified a set of undesirable events that should be avoided, the threat monitoring means can observe the system to see if it is possible to formulate a plan to bring about an undesirable event. If it finds such a plan, the threat intervention means takes an action to break a link in that plan.

In the context of an embodiment of Cy-QLAP, a DBN succeeds if its antecedent event leads to the consequent event in the environment. A DBN is sufficiently reliable, in an embodiment, if the probability of success is greater than 0.75 in some state. A DBN is satisfied, in an embodiment, if the probability of success of the DBN is greater than 0.75 in the current state. If a DBN has a context, and the context is satisfied, the satisfied context value is the variable and value that satisfies it. For example, if a DBN is satisfied when variable v=True, and v=True in the current state, then the satisfied context value is v=True. A goal is achieved if it is made to be true. For example, if the goal is u=False, and u=False in the current state, then that goal is achieved. In alternative embodiments the threshold value may be a number other than 0.75, it may be different for evaluating “sufficiently reliable” vs. “satisfied”, or it may vary based on context or be controllable.

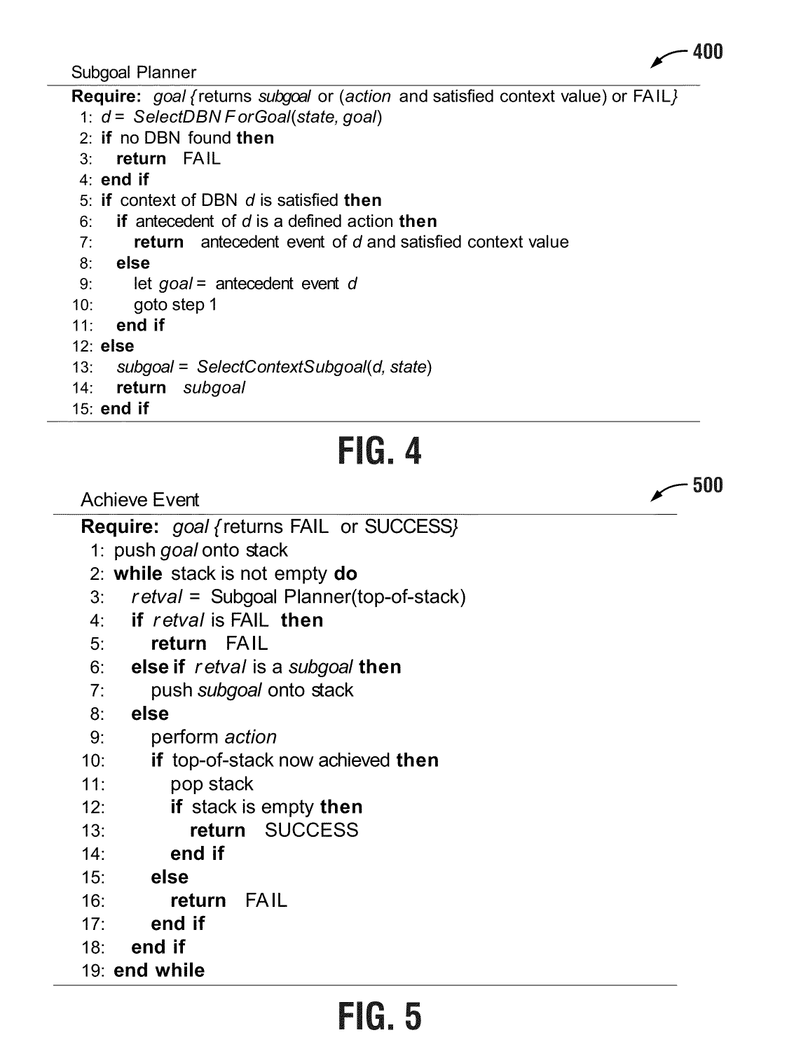

An embodiment of Cy-QLAP uses a Threat Monitoring Module and a Threat Intervention Module. An exemplary Threat Monitoring Module watches the system to see if it is possible to bring about an undesirable event. It does this by continually performing the Subgoal Planner algorithm (400) (FIG. 4) and passing it each undesirable event as a goal. If the subgoal planner returns an action, that means that the undesirable event can be achieved. In this case, the subgoal planner also returns the satisfied context value that makes this possible. Cy-QLAP is then able to make sure this plan cannot be achieved by an adversary by calling a Threat Intervention Module. Subgoal Planner Algorithm (400) in an embodiment uses two functions. SelectDBNForGoal: finds the sufficiently reliable DBN that is most reliable in the current state, and SelectContextSubgoal: finds the context value where the DBN is most reliable and returns it as a subgoal.

An exemplary Threat Intervention Module changes the environment so that the threat found by the monitoring system is negated and cannot be exploited by an adversary. It does this by unsetting the satisfied context value that makes possible the plan to bring about the undesirable event. Specifically, it performs the Achieve Event algorithm 500 (FIG. 5) with the negation of the satisfied context value as the goal.

Cy-QLAP is designed to use knowledge learned through exploration to take actions to proactively thwart attacks. Presented here is an experiment performed to evaluate this ability.

Cy-QLAP was evaluated in the simple environment (200) shown in FIG. 2. The environment consists of a Windows 7 end node (205) that was designated for protection and a Linux Ubuntu virtual machine (210) that is used to learn the effects of external actions. Cy-QLAP runs on the end node (205) and has a remote process on the virtual machine (210). Cy-QLAP takes exploratory actions both locally on the end node (205) and remotely from the virtual machine (210). These actions relate to a set of sensitive files that are designated for protection on the end node (205). To learn about the effects of both its internal and external actions, Cy-QLAP reads the Windows Registry (207) and the Windows logs (208), and it runs a packet sniffer (209).

State variables determine the state space of the system. Those variables are:

file_open(x): Bool is True when file x is open. Cy-QLAP determines the value of this variable by looking at the system log.

registry_created(x): Bool is True if a registry entry exists indicating a file share exists on x. Cy-QLAP determines this by looking at the Windows Registry.

exfiltration_obs(x): Bool is True if exfiltration of file x is observed. Cy-QLAP determines this by sniffing packets.

Actions are state variables that the agent can set directly. The actions are:

open_file(x): Open file named x on the protected end node from the remote virtual machine using the Samba file sharing protocol.

create_share(x): Open a file share on file x on the protected end node.

destroy_share(x): Close a file share on file x on the protected end node.

copy_file_remote(x): Copy file x off the protected end node to the remote virtual machine using the Samba file sharing protocol.

The environment contains two files. At each timestep, Cy-QLAP will sense the environment and take a random action. At time t, an action will have value True if it was taken and value False otherwise. Each timestep will result in a state-action vector of the form: [file_open_1, file_open_2, registry_created_1, registry_created_2, exfiltration_obs_1, exfiltration_obs_2, open_file_1, open_file_2, close_file_1, close_file_2, create_share_1, create_share_2, destroy_share_1, destroy_share_2, copy_file_remote_1, copy_file_remote_2].

FIG. 7 shows a representation (700) of the file exfiltration scenario. The opening up of a Windows file share creates a registry entry (702). Cy-QLAP can then notice that this allows the file to be accessed by looking at the Windows log (704). Cy-QLAP can then notice that this log indicates that exfiltration evidence can be found through packet capture (706).

New Registry Entry (702). System configuration information is stored in the Windows Registry. The registry consists of a set of keys and corresponding values. The values themselves can be sets of keys and values, so the registry is hierarchical, like a file system. There are hundreds of thousands of registry keys and values. Registry entry (702) is created when a file share is opened. The experiment protocol called for creation of a sensitive document in C: \secret folder. By looking at the registry using the regedit utility, it can be seen that there is a share on the folder for the key HKEY LOCALMACHINE\SYSTEM\ControlSet00\services\LanmanServer\Shares.

New Log Record (704). Windows creates log entries when a user logs in, installs an application, or connects the computer to a wireless network, among many other events. The Windows log can be viewed by going to the run or search box and typing eventvwr.msc. Some logs, such as logs on file sharing, need to be turned on explicitly. In this embodiment, the file sharing audit log was turned on. Log entry (704) is created when a file share is opened.

Evidence of File Exfiltration (706). One approach to identify file exfiltration is to use a packet sniffer and to then search for the file within the packets. Cy QLAP can perform packet inspection to monitor what enters and leaves the machine. Cy-QLAP can look for specific pieces of information and create events of the form (found information, time).

The experimental procedure consisted of two phases. During the first phase, Cy-QLAP explored the environment to learn a set of causal models that could be used to represent the dynamics of the environment. During the second phase, Cy-QLAP used those learned causal models to monitor and actively protect the system.

To learn contingencies, Cy-QLAP explored the environment by taking 1,000 actions and observing their effects. This process was not optimized for speed and lasted about four hours. Most of the time was spent waiting for the packets to come across or for the system log to be updated. The processing time needed for Cy-QLAP learning was negligible. To learn DBNs, Cy-QLAP began with the learned contingencies and took an additional 1,000 actions and observed their effects. This process also lasted about four hours.

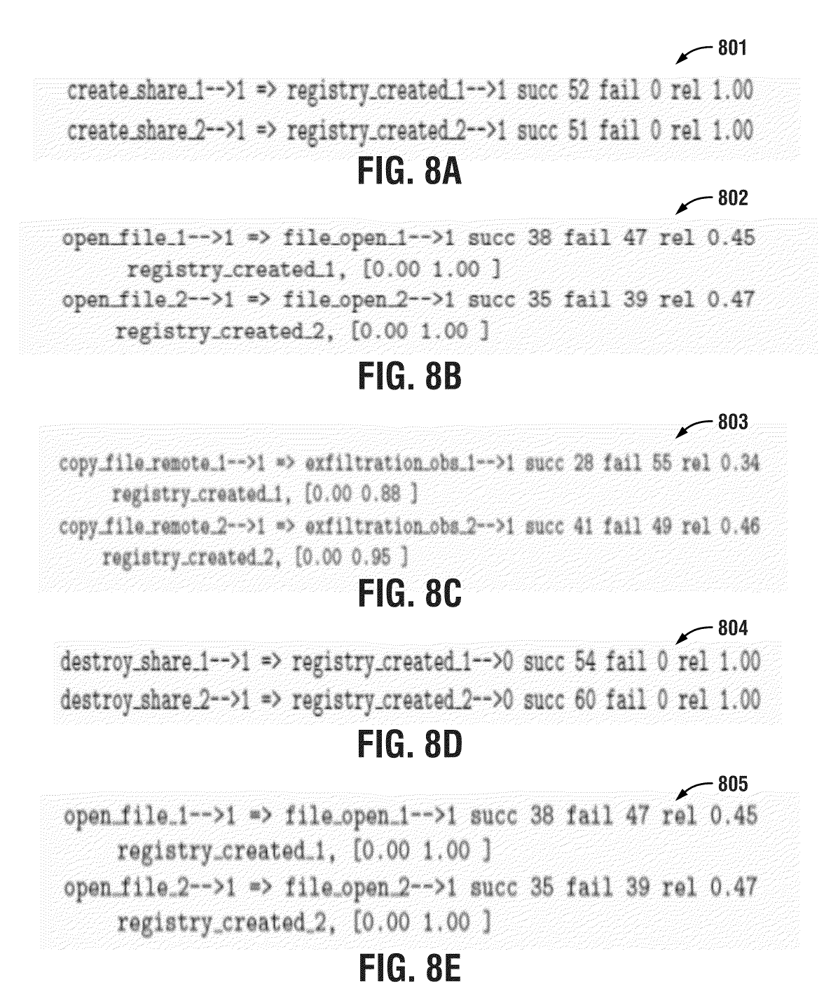

Cy-QLAP was able to learn the dynamics of the environment. FIGS. 8(a)-8(e) show the DBNs learned by Cy-QLAP. In FIGS. 8(a)-8(e), the notation X—>x means that the event of variable X going to value x occurred. In this case, 1 is True and 0 is False. The notation A=>B means that the contingency consists of the antecedent event A leading to the consequent event B. The top line following the contingency contains: succ, which means the number of times the contingency was successful; fail, the number of times the contingency failed; and rel, the reliability of the contingency. The second line contains the conditional probability table of the context, if one was learned. The first value is the variable in the context. The final value is the conditional probability table for the contingency given each value of the context variable [False, True].

The DBN (801) depicted in FIG. 8(a) shows that Cy-QLAP learned that creating a file share on a file results in a new registry entry indicating the share.

The DBN (802) depicted in FIG. 8(b) shows that, by trying to open files from the remote process, Cy-QLAP learned that once there is that registry entry, it can open a file.

The DBN (803) depicted in FIG. 8(c) shows that Cy-QLAP learned that if a file share is created, it can send it off the computer.

The DBN (804) depicted in FIG. 8(d) shows that Cy-QLAP also learned that if it closes a file share, it can change the registry entry so that the file can no longer be opened.

It can be seen from the conditional probability table of the two DBNs (805) depicted in FIG. 8(e) that Cy-QLAP learned that if the registry value is not there, then the file will not be able to be opened.

The system should prevent file exfiltration by preventing file_exfiltration_1=True or file_exfiltration_2=True. When passing the Threat Monitoring System various states where file exfiltration was not possible (file sharing was turned on), the monitoring system returned that all was ok. However, it was passed the state of the world where registry_created_1=True, it indicated that it was possible to exfiltrate the file, and it stated that the world needed to be changed so that registry_created_1=False.

The goal of registry_created_1=False was passed to the Threat Intervention Module. The module returned that the required action was destroy_share. This process worked in the same way when a file share was set up for file 2 and it was in danger.

What is noteworthy about this scenario is that the human did not have to specify what the threat was or how to prevent it. The human only needed to specify what should be prevented, and Cy-QLAP figured out how the undesirable event could be brought about and how to take action to prevent it. Cy-QLAP autonomously learned to predict and defend the system.

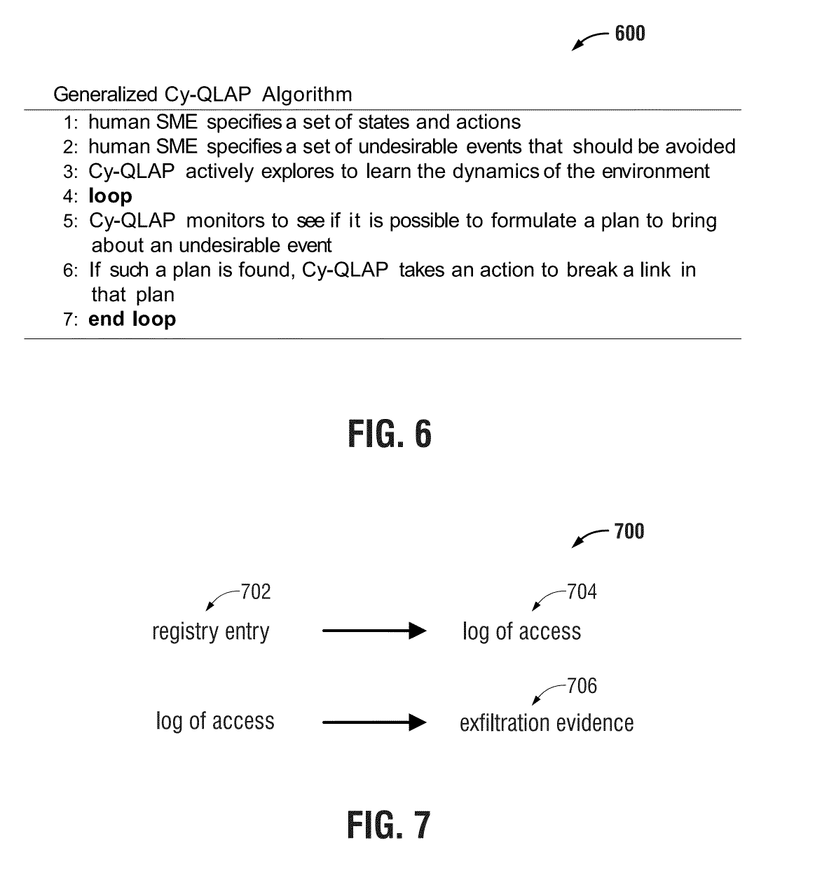

Cy-QLAP is a domain-general protection system as shown in the Generalized Cy-QLAP Algorithm (600) (FIG. 6). Using this generalized algorithm, Cy-QLAP is able to work to defend an arbitrary system. Cy-QLAP represents a step toward increased automation and intelligence of defense systems. This increased intelligence and autonomy raises at least two issues. The first issue is that of control. The flip side of an autonomous system is that the human operators have less control over its actions. Cy-QLAP actively defends a system by taking protective actions. Cy-QLAP chooses which actions are most important in a given situation, and this creates the possibility that Cy-QLAP could choose an action that would be undesirable from the perspective of the human operator. This problem is inherent in any system with autonomy, but, as described above, the inner workings of Cy-QLAP are human understandable. This enables the analyst and the algorithm to work as a team, and can allow our defenses to have the best of both machine intelligence and human intelligence.

A second issue that stems from intelligence and autonomy is the level of abstraction at which the algorithm reasons about the world. Cy-QLAP learns a causal model to describe a system, and it can use that causal model to simulate an adversary to thwart and attack, but Cy-QLAP must be given the set of possible events over which it should reason.

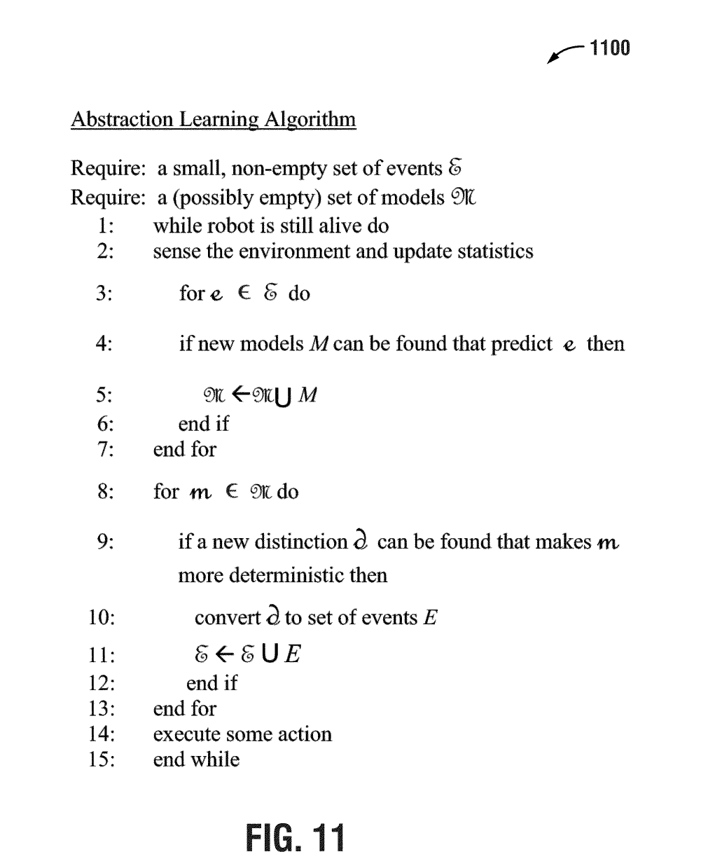

Abstraction Learning Using Predictive Models. An alternative embodiment of a machine learning approach is shown employs exemplary algorithm (1100) (FIG. 11) to provide a top-down learning approach that can learn abstractions suitable for reasoning and further learning. The method begins with a coarse representation consisting of a few features. Changes in feature values in the environment gives rise to events, and therefore the algorithm begins with a non-empty set of events ε. The method seeks to find regularities in the environment, and the algorithm begins with a set of predictive models [symbol] . The algorithm requires at least one event to begin the distinction learning process, but the initial set of predictive models can be empty.

The algorithm continually searches for new models that predict its current set of events ε. A new model can be created when, in an embodiment, the learning machine senses a new contingency in the environment. For example, continuing the “light switch” example described in connection with FIG. 1, the learning machine may observe, when it senses the environment, that a fan begins to operate within the soon window after the “light switch” event. This newly-observed contingency can be used to create a new model of the environment. If and when a new model is found, it is added to the current set of models [symbol] . New features come from finding new distinctions, and for each predictive model, m ∈ [symbol] , the algorithm searches for some new distinction that makes m more deterministic. If such a distinction is found, it is converted to a set of events E, which is added to the total set of events ε. An exemplary embodiment assumes that distinctions learned to make predictive models more reliable are broadly useful to the learning machine, and therefore on the next iteration of the while loop the algorithm will have new events that it can learn models to predict.

In embodiments the sets of models and events grow over time. In alternative embodiments, to contain model growth, models that do not become sufficiently reliable through added distinctions can be removed. In other embodiments, distinctions (and therefore events) that no longer appear useful may be removed. In yet other embodiments, there is only one model.

Abstraction Learning Using Dynamic Bayesian Networks and Landmarks. In an exemplary embodiment, the learning machine comprises a robot, models are represented using Dynamic Bayesian Networks (DBNs), and distinctions are represented as discretizations of continuous variables.

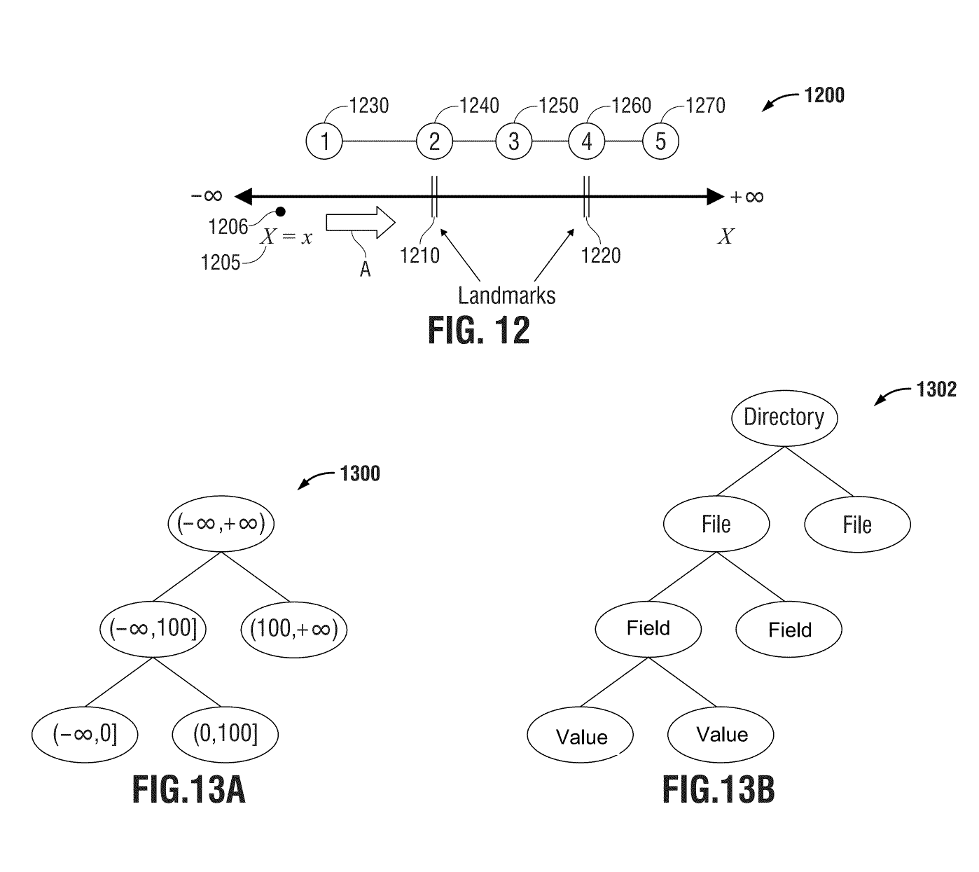

In an embodiment, a distinction can be implemented by discretizing continuous variables using landmarks. A landmark is a symbolic name for a point on a number line. FIG. 12 shows a number line (1200) for a variable X (1205) with two landmarks L₁ (1210) and L₂, (1220). The two landmarks partition the infinite set of values for variable X into five qualitative values or ranges of values for X (1230, 1240, 1250, 1260, 1270) called qualitative values. In this example, the five qualitative values or ranges of values for X are: X<L₁, X=L₁, L₁<X<L₂, X=L₂, and L₂<X. The current value of X=x is shown at 1206. Arrow A indicates that the value of X is increasing. FIG. 13(a) depicts a hierarchy over a continuous variable with two landmarks. Initially there are no landmarks. Learning a landmark at 100 splits the state space. The left state is split again when another landmark is learned at 0.

To begin with a small set of events, as used in embodiments of Algorithm (1100) (FIG. 11) for each continuous variable X, an associated variable X′ is created that is the first derivative of X. The variable X′ is given a landmark at 0. Before any landmarks are created on X, the robot cannot distinguish between the different values of X; it can only know that it is between −∞ and +∞. But because X′ has a landmark at 0, the robot can know if the value of X is increasing, decreasing, or remaining steady.

As the robot learns new landmarks, such as those shown in FIG. 12, the robot can make more distinctions between the different qualitative values of variable X. Each new landmark L creates two new events because the qualitative value X=x can be reached from either above or below on the number line and because the event that was previously there is no longer reachable. Once a landmark is placed at 0, for example, the range of values from (−∞, 100] is no longer reachable.

Learning New Distinctions. For a model m that predicts event A will lead to event B, the supervisory signal comes from observing event A and then noting if event B soon follows. This is called an application of model m. For each application of model m, the environment replies with True (i.e., the environment serving as the supervisory signal has given the value True) if event B follows event A, and with False otherwise.

To learn new landmarks to implement line 9 of Algorithm (1100) (FIG. 11), the algorithm can note the real value of each variable Vᵢ each time model m is applied (line 2 of Algorithm 1100). The algorithm can then determine if there is a landmark that, if created, would make the CPT of model m more deterministic. If so, the algorithm creates that landmark. The robot will then have two new events that it can try to predict.

Generalizing Landmark Learning. In embodiments of abstraction learning (such as described above in connection with Algorithm 1100 (FIG. 11)), a space is set up over which a learning machine can search for new distinctions that make predictive models more deterministic. An embodiment of this process was described above (and illustrated in FIG. 13(a)) in relation to discretizing continuous variables.

In an alternative embodiment, instead of searching for distinctions over the range of a continuous variable (as discussed above), the learning machine searches over an abstraction hierarchy. An exemplary abstraction hierarchy is a domain-specific, user-defined hierarchy with different levels of representation at each layer. Each level of the abstraction uses a different set of attributes to describe the system. In an embodiment, the different levels of abstraction and/or relevant attributes are user defined. In alternative embodiments the different levels of abstraction and/or relevant attributes may be determined by the system under investigation.

FIG. 13(b) illustrates an exemplary abstraction hierarchy (1302) for configuration files in a computer operating system. An exemplary configuration file is the Windows Registry. Each configuration file consists of a set of (field, value) pairs that determine how an application would run. The values themselves can be sets of fields (or keys) and values, so the configuration file is hierarchical, like a file system. Traversing this exemplary abstraction hierarchy from top to bottom, from a higher level of abstraction to a lower level of abstraction, the hierarchy is: (1) File Directory; (2) a specific folder of configuration files; (3) a specific configuration file; (4) a specific field of the configuration file; and (5) a specific value of the field.

In an exemplary application, the learning machine may be searching for events that cause a mission-critical program to fail. In one hypothetical example, an event associated with failure may be a change in a single field of the configuration file for the program, for example, a change in a hash value that indicates that a specific configuration file has been modified. This might be the level of detail needed to predict an event that the robot cares about, i.e., failure of the mission-critical program. By searching over this hierarchy, the learning machine may learn that it does not need to know exactly how the file was modified, only that it was modified.

The learning machine may also learn, by searching over all fields of the configuration file, that the only field that really matters is the port number (port,100). Thus the learning machine could learn that if the hash value changes (meaning that the file has been modified), sometimes the mission will fail, and sometimes it won't; but if the value of port number has been changed, then the mission is in danger. Further, the learning machine may gain greater insight by going to a lower level of the abstraction hierarchy and exploring all values of the field of interest. Focusing specifically on the port number values, it may be that a change in the port number will not cause failure unless the port is changed to a specific number, say 25.

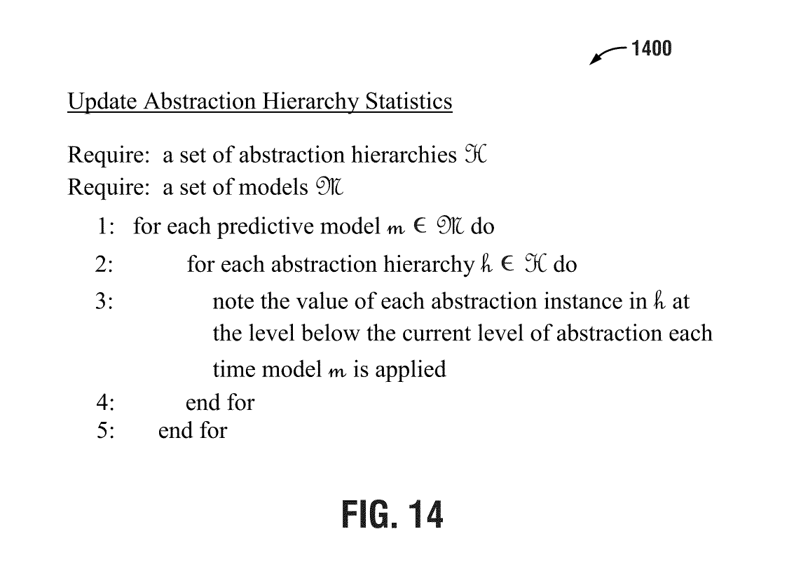

Updating Statistics. Algorithm (1400) (FIG. 14) describes an exemplary method of maintaining and updating statistics in an abstraction hierarchy, such as, for example, as discussed in line 2 in Algorithm (1100) (FIG. 11). Exemplary statistics updating method (1400) requires a set of abstraction hierarchies, and a set of models. For each predictive model [symbol] , and for each abstraction hierarchy [symbol] , the value of each abstraction instance in [symbol] at the abstraction level below the current level of abstraction is noted for each time model applied.

Predictive models allow a robot to learn abstractions because each model can serve as a self-supervised learning problem. The abstractions learned using this top-down method will not be uniform, and this is as it should be. The robot ought to have deeper knowledge in areas that matter and less knowledge in areas that do not. If the robot can perceive the world at the right level of detail relative to its goals, the applicability of existing reasoning and planning methods can be extended.

An exemplary learning machine for use with the methods, functions and algorithms described herein comprises a computing system, one or more input sensors, and one or more output controllers.

An input sensor in embodiments of a learning machine may include one or more of a packet analyzer, network analyzer, protocol analyzer, packet sniffer, ethernet sniffer, wireless sniffer, contact sensor, noncontact sensor, tactile sensor, electromechanical sensor, limit switch, photoelectric sensor, photo receiver, programmable logic controller, presence sensing device, proximity sensor, ultrasonic sensor, infrared sensor, RADAR, LIDAR, SONAR, audio sensor, microphone, radio receiver, microwave receiver, optical character reader, bar code scanner, 2D code reader, range sensor, image sensor, memory reader, memory controller, scanner, digital camera, scanner, motion sensor, accelerometer, gyroscope, meteorological sensor, altitude sensor, anemometer, air velocity sensor, electrode, chemical sensor, or gas or liquid analzer. Input sensors may further include one or more of any mechanism of acquiring data stored on or used in a computer network, any program that reads the contents of other files or programs or computer memory, and any other means of learning the state of a computer system. In general, any means by which a computer system can collect or receive data or information about its environment can be considered an input sensor and the scope of the invention is not limited to the specific embodiments of input sensor listed here. In certain embodiments, one or more input sensors may be loosely coupled to the computer system, including remotely over the internet. In other embodiments, one or more input sensors may be tightly coupled to the computer system.

An output controller in embodiments of a learning machine may include one or more of a network security appliance, network security software, bus controller, logic controller, computer control signal, memory controller, light emitting diode (LED), photo transmitter, programmable logic controller, power-supply unit, hydraulic actuator, electric actuator, pneumatic actuator, linear actuator, air muscle, muscle wire, electroactive polymers, DC motor, AC motor, piezoelectric motor, ultrasonic motor, elastic nanotube, mobile manipulator, and locomotor. Output controllers may further include any mechanism that can act on another machine, a computer system, or a network such as shutting down a port, changing values in memory or registers, changing configuration files, providing input to another program, calling the operating system, or issuing a network command or request. In general, any means by which a computer system can operate on or affect its environment can be considered an output controller and the scope of the invention is not limited to the specific embodiments of output controller listed here. In certain embodiments, one or more output controllers may be loosely coupled to the computer system, including remotely over the internet. In other embodiments, one or more output controllers may be tightly coupled to the computer system.

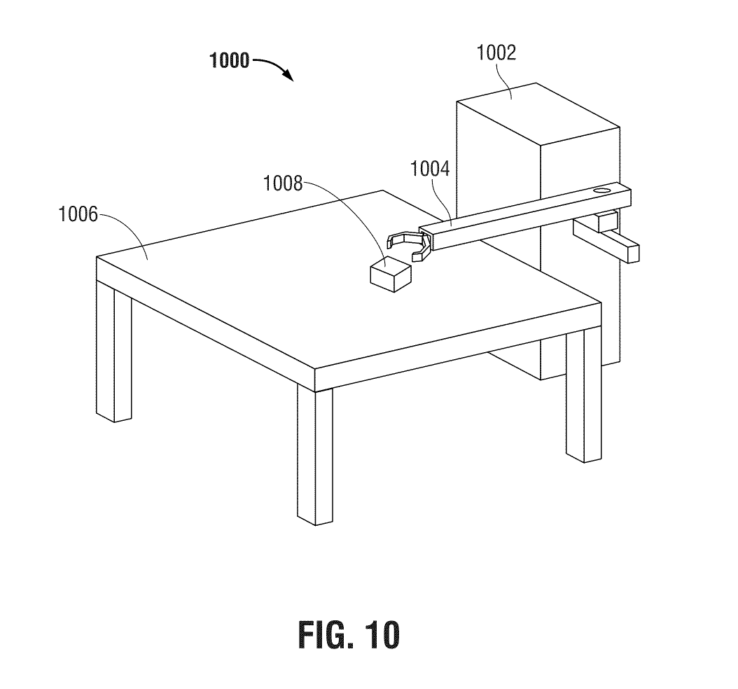

FIG. 10 illustrates an exemplary embodiment of a learning machine 1000. In one embodiment, the learning machine may be a robot. An exemplary embodiment of a robot is shown on robot 1002. The robot 1002 includes an output controller in the form of a movable arm 1004 with which the robot act on block 1008 resting on a table 1006. Robot 1002 perceives its environment as multiple variables, and autonomously explores its environment to learn actions and abstractions. In other embodiments, a learning machine may be a computer that analyzes performance of an operating system on one or more computers. The computer may include one or more input sensors coupled to the computer that include a program that can intake and read logs and system state variables. The computer may also include an output controller coupled to the computer that can send commands to the operating system. In yet other embodiments, the learning machine may be a computer connected to a network of computers where one or more input sensors monitor traffic over the network and one or more output controllers issue commands to any other computers on the network.

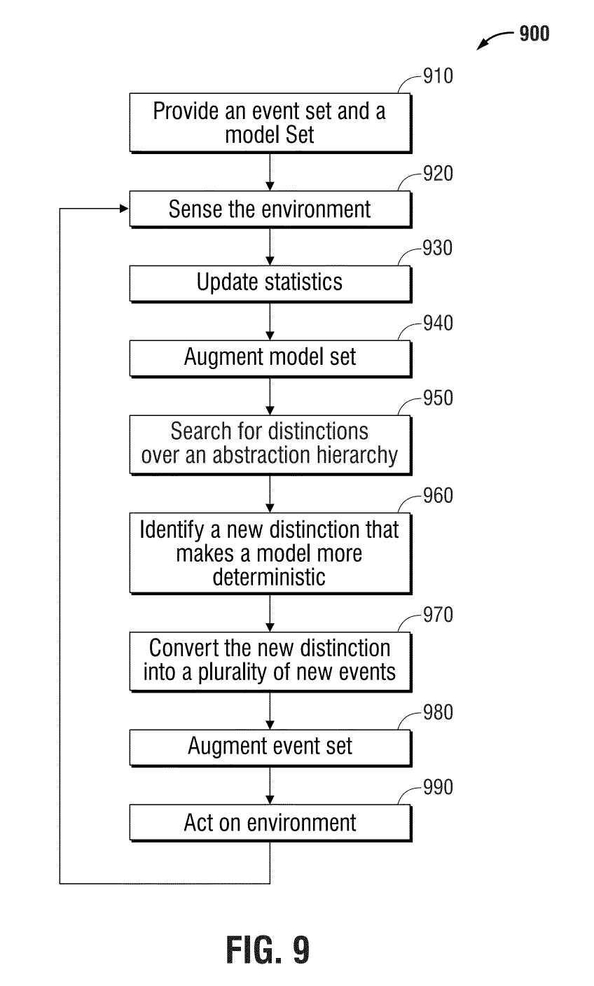

FIG. 9 depicts the steps of an exemplary machine learning method (900) that uses an abstraction hierarchy. Machine learning method 900 is performed by a learning machine. Initially, an event set and a model set are provided and, in an embodiment, stored in memory of the computer system of the learning machine, step (910). The machine will sense its environment, step (920) using one or more input sensors. After sensing the environment the learning machine may recognize one or more new contingencies. The machine will update statistics, step (930), including in an embodiment statistics stored in the memory of the computer system. In an embodiment the learning machine may optionally augment the model set, step (940). In an embodiment, the learning machine may develop an initial model based on an observed contingency and may never develop another predictive model. In an alternative embodiment the learning machine may develop one or more new models based on contingencies sensed in the environment. The learning machine next searches for distinctions over an abstraction hierarchy, step (950). For each distinction that it identifies, the learning machine tests to determine if the new distinction makes at least one of the models in the model set more deterministic, step (960). Any such distinction is converted into a plurality of new events step (970), and in step (980), the event set is augmented with the new events. In step (990), the machine acts on its environment using, in an embodiment, one or more of the output controllers. The machine may continually sense its environment, step (920), during this exemplary machine learning method (900). The scope of the invention is not limited by the specific sequence of steps illustrated in exemplary machine learning method 900 and the steps may be performed in a variety of sequential orders.

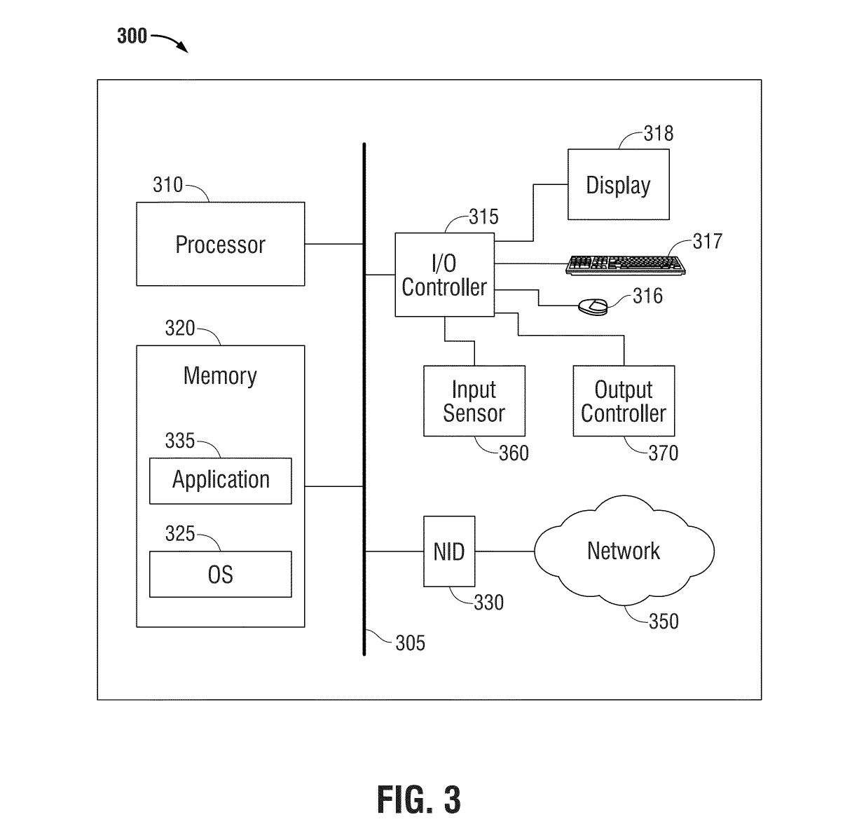

A learning machine comprises a computer system which may be any device or system with sufficient computing power, memory and connectivity to be able to sense, control and otherwise interact with its environment to perform the functions, methods and algorithms described herein. Shown in FIG. 3 is a block diagram representation of an exemplary computer system 300 for use in embodiments of a learning machine. Computer system 300 includes processor 310 connected to memory 320 via system interconnect 305. Also connected to system interconnect 305 is I/O controller 315, which provides connectivity and control for user input devices and, in embodiments, output devices.

Embodiments of processor 310 comprise without limitation that includes one or more central processing units (CPU), one or more dedicated processors, a single shared processor, a plurality of individual processors, one or more digital signal processors, one or more remote processors, one or more local processors, one or more JAVA virtual machines, and one or more processor emulators provided locally or remotely.

Embodiments of memory 320 comprise one or more components in any functional combination of short-term memory, random access memory (RAM), read-only memory (ROM), EEPROM, flash memory, non-volatile data storage, long-term memory, read-only memory, persistent storage, CD-ROM, digital versatile disks (DVD) or other optical media, drive magnetic disk storage, USB drives, local memory storage, remote memory storage, memory situated on a remote server, and memory situated in the cloud. Generally, memory 320 may include any media with sufficient capacity to store the software code and data structures designed and configured to perform the methods, functions and algorithms described herein. Memory 320 may operating system software and one or more modules of software including coded instructions stored in memory or other tangible media that can be and is executed by processor 310.

Embodiments of computer system 300 may be coupled to another computer system or computer network 350. In an exemplary embodiment computer system 300 includes a network interface device (NID) 330 to communicate with network 350. The topology of network 350 may range from a simple two device network to a network comprising thousands or more interconnected devices. Computer network 350 may be an intranet or a local area network (LAN). In more complex implementations, the network may be a wide area network (WAN), such as the Internet or any collection of smaller networks and gateways that utilize Ethernet and/or Transmission Control Protocol/Internet Protocol (TCP/IP) or other communications protocols to communicate with each other. Computer system 300 may communicate with network 350 via any modulated data signal, meaning a signal that has one or more of its characteristics set or changed in such a manner as to encode information in the signal. By way of example, and not limitation, a modulated data signal includes wired media such as a wired network, conventional POTS telephone system, or direct-wired connection, and wireless media such as acoustic, RF, microwave, cellular telephone, cellular data, infrared and other wireless media. NID 1130 may be a modem and/or network adapter, for example, depending on the type of network and connection to the network. It is however understood that application of the various methods, functions and algorithms of embodiments of the invention may occur within a computer system 300 that is not connected to an external network.

Embodiments of user input devices comprise one or more of a mouse or other pointing device 316, keyboard 317, and other embodiments not illustrated here, including touch screen, network connection, wireless connection, telephone, cell phone, optical connection, infrared connection, and connection via system interconnect 305. A user input device includes, broadly, any facility by which computer system 300 receives data, information, instructions, control signals, or data. A user input device may be coupled to computer system 300 via I/O controller 315 or system interconnect bus 305. A user input device may be local to or remote from computer system 300, and in an alternative embodiment one or more user input devices may be coupled to computer system 300 via NID 330 and network 350.

Embodiments of an output devices may include any type of device for presenting visual information such as, for example, display 318, which may include a computer monitor, flat-screen display, mobile device screen, light projector, or hologram projector. Output device also include any type of device for presenting information in other formats, such as a printer or speakers or other device for providing information in audio form. An output device may be coupled to computer system 300 via I/O controller 315, system interconnect bus 305, or remotely through NID 330. An output device may be local to or remote from computer system 300.

Computer system 300 is coupled to one or more input sensors 360 and one or more output controllers 370. Computer system 300 may be coupled to an input sensor 360 or an output controller 370 via I/O controller 315 and/or USB or other local bus. An input sensor or output control may be local to or remote from computer system 300, and in an embodiment one or more input sensors or output controllers may be coupled to computer system 300 via NID 330 and network 350.

Those of ordinary skill in the art will appreciate that the hardware components depicted in FIG. 3 are a generic illustration of a computer system and may vary from system to system. Thus, the depicted example is not meant to imply architectural limitations with respect to the present invention.

In addition to the above described hardware components of computer system 300, various features of embodiments are provided as software instructions or code stored within memory 320 or other storage (not shown) and executed by processor 310. Stored in memory 320 and executed by CPU 310 are a number of software components, including operating system (OS) 325 (e.g., Microsoft Windows®, a trademark of Microsoft Corp, or GNU®/Linux®, registered trademarks of the Free Software Foundation and The Linux Mark Institute) and one or more software applications 335 implementing the methods, functions and algorithms described herein.

The exemplary algorithms, functions and methods illustrated herein, including but not limited to algorithms 400, 500, 600, 900, 1100 and 1400, may be implemented in software applications or other code in any configuration and by any means known to a person of ordinary skill in the art to make computer instructions that when loaded into memory 310 and executed by processor 320 cause the learning machine to perform the exemplary algorithms, functions and methods illustrated herein.

Embodiments of computer system 300 may be implemented on a hardware device or a combination of hardware and software. Computer system 300 may be implemented in a variety of computer architectures (for example, a client/server type architecture, a mainframe system with terminals, an ASP model, a peer to peer model, and the like) and other networks (for example, a local area network, the internet, a telephone network, a wireless network, a mobile phone network, and the like), and those other implementations are within the scope of the inventions disclosed herein since the inventions disclosed herein are not limited to any particular computer architecture or network.

Those of skill will recognize that the techniques of the embodiments described herein may be implemented to advantage in a variety of sequential orders and that the present invention may be generally implemented in computer readable media for introduction into or use with embodiments of a learning machine. In such cases, instructions for executing the functions, methods and algorithms described herein when executed by a processor will be embedded in the computer readable media.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated. The described embodiments illustrate the scope of the claims but do not restrict the scope of the claims.

1. A method of machine learning for use with a learning machine, the learning machine comprising a first input sensor adapted to sense an environment, a first output controller adapted to act on the environment, and a computing system comprising a user input device, a memory, and a processor, comprising:
providing an event set comprising one or more events;
providing a model set adapted to comprise one or more models, wherein each model can predict at least one of the one or more events in the event set;
iteratively repeating the following sequence of steps:
sensing the environment with the first input sensor;
updating statistics;
searching for new distinctions over a first abstraction hierarchy to identify a new distinction that makes a first model more deterministic;
converting the new distinction into a plurality of new events;
augmenting the event set with the plurality of new events; and
acting on the environment using the first output controller.

2. The method of machine learning of claim 1, wherein the first abstraction hierarchy does not comprise the range of a continuous real variable.

3. The method of machine learning of claim 1, wherein the first abstraction hierarchy comprises a domain-specific user-defined hierarchy with different levels of representation at each layer.

4. The method of machine learning of claim 3, further comprising:
for each model in the model set, noting the value of each abstraction instance in the first abstraction hierarchy at the level below the current level of abstraction each time the model is applied.

5. The method of machine learning of claim 3, wherein the first model comprises a Dynamic Bayesian Network (DBN) and a Conditional Probability Table (CPT) comprising one or more context variables, and wherein identifying a new distinction that makes the first model more deterministic further comprises:
noting the value of each conditional variable in the CPT of the first model; and
identifying a distinction that makes the CPT of the first model more deterministic.

6. The method of machine learning of claim 5, wherein identifying a new distinction that makes the first model more deterministic further comprises searching for new distinctions over a second abstraction hierarchy, wherein the second abstraction hierarchy does not comprise the range of a continuous real variable, wherein the second abstraction hierarchy comprises a domain-specific user-defined hierarchy with different levels of representation at each layer, further comprising:
for each model in the model set, noting the value of each abstraction instance in the second abstraction hierarchy at the level below the current level of abstraction each time the model is applied.

7. The method of machine learning of claim 3, wherein the learning machine comprises a robot.

8. The method of machine learning of claim 1, further comprising augmenting the model set with at least one new model, wherein the at least one new model can predict at least one of the one or more events in the event set.

9. A learning machine, comprising:
a computing system comprising a user input device, a processor, and a memory, wherein the memory comprises an event set comprising one or more events and a model set adapted to comprise one or more models, wherein each model can predict at least one of the one or more events in the event set;
a first input sensor coupled to the computing system, the first input sensor adapted to sense an environment; and
a first output controller coupled to the computing system, the first output controller adapted to act on the environment,
wherein the memory further comprises instructions which when executed by the processor cause the learning machine to iteratively repeat the functions of:
sensing the environment with the first input sensor;
updating statistics;
searching for new distinctions over a first abstraction hierarchy to identify a new distinction that makes a first model more deterministic, wherein the first model is one of the one or more models in the model set;
converting the new distinction into a plurality of new events;
augmenting the event set with the plurality of new events; and
acting on the environment using the first output controller.

10. The learning machine of claim 9, wherein the first abstraction hierarchy does not comprise the range of a continuous real variable.

11. The learning machine of claim 9, wherein the first abstraction hierarchy comprises a domain-specific user-defined hierarchy with different levels of representation at each layer.

12. The learning machine of claim 11, further comprising:
for each model in the model set, noting the value of each abstraction instance in the first abstraction hierarchy at the level below the current level of abstraction each time the model is applied.

13. The learning machine of claim 11, wherein the first model comprises a Dynamic Bayesian Network (DBN) and a Conditional Probability Table (CPT) comprising one or more context variables, and wherein identifying a new distinction that makes the first model more deterministic further comprises:
noting the value of each conditional variable in the CPT of the first model; and
identifying a distinction that makes the CPT of the first model more deterministic.

14. The learning machine of claim 13, wherein identifying a new distinction that makes the first model more deterministic further comprises searching for new distinctions over a second abstraction hierarchy, wherein the second abstraction hierarchy does not comprise the range of a continuous real variable, wherein the second abstraction hierarchy comprises a domain-specific user-defined hierarchy with different levels of representation at each layer, further comprising:
for each model in the model set, noting the value of each abstraction instance in the second abstraction hierarchy at the level below the current level of abstraction each time the model is applied.

15. The learning machine of claim 11, wherein the learning machine comprises a robot.

16. The learning machine of claim 9, further comprising augmenting the model set with at least one new model, wherein the at least one new model can predict at least one of the one or more events in the event set.

17. The learning machine of claim 1 or 9, wherein the memory comprises one or more of short-term memory, random access memory (RAM), read-only memory (ROM), EEPROM, flash memory, long-term memory, read-only memory, persistent storage, CD-ROM, digital versatile disks (DVD) or other optical media, magnetic disk storage, USB drives, local memory storage, remote memory storage, memory situated on a remote server, and memory situated in the cloud.

18. The learning machine of claim 1 or 9, wherein the processor comprises one or more of a dedicated processor, a single shared processor, a plurality of individual processors, one or more digital signal processors, one or more remote processors, one or more local processors, a JAVA virtual machine, and one or more processor emulators provided locally or remotely.

19. The learning machine of claim 1 or 9, wherein the user input device comprises one or more of a mouse, keyboard, touch screen, network connection, wireless connection, telephone, cell phone, optical connection, and infrared connection.

20. The learning machine of claim 1 or 9, wherein the input sensor comprises one or more of a packet analyzer, network analyzer, protocol analyzer, packet sniffer, ethernet sniffer, wireless sniffer, contact sensor, noncontact sensor, tactile sensor, electromechanical sensor, limit switch, photoelectric sensor, photo receiver, programmable logic controller, presence sensing device, proximity sensor, ultrasonic sensor, infrared sensor, RADAR, LIDAR, SONAR, audio sensor, microphone, radio receiver, microwave receiver, optical character reader, bar code scanner, 2D code reader, range sensor, image sensor, memory reader, memory controller, scanner, digital camera, and scanner.

21. The learning machine of claim 1 or 9, wherein the input sensor comprises means of collecting information from the environment of the learning machine.

22. The learning machine of claim 1 or 9, wherein the output controller comprises one or more of a network security appliance, network security software, bus controller, logic controller, computer control signal, memory controller, light emitting diode (LED), photo transmitter, programmable logic controller, power-supply unit, hydraulic actuator, electric actuator, pneumatic actuator, linear actuator, air muscle, muscle wire, electroactive polymers, DC motor, AC motor, piezoelectric motor, ultrasonic motor, elastic nanotube, mobile manipulator, and loco motor.

23. The learning machine of claim 1 or 9, wherein the output controller comprises means for controlling the environment of the learning machine.
